(19) United States
(12) Patent Application Publication
(10) Pub. No.: US 2025/0013418 A1
(43) Pub. Date: Jan. 9, 2025

(54) WORK ASSISTANCE SYSTEM

(71) Applicant: KAWASAKI JUKOGYO KABUSHIKI KAISHA, Kobe-shi, Hyogo (JP)

(72) Inventors: Atsuki NAKAGAWA, Kobe-shi (JP); Naohiro NAKAMURA, Kobe-shi (JP); Masahiro IWAMOTO, Kobe-shi (JP); Shigekazu SHIKODA, Kobe-shi (JP); Osamu TANI, Kobe-shi (JP); Masahiko AKAMATSU, Kobe-shi (JP); Singo YONEMOTO, Kobe-shi (JP)

(73) Assignee: KAWASAKI JUKOGYO KABUSHIKI KAISHA, Kobe-shi, Hyogo (JP)

(21) Appl. No.: 18/697,929

(22) PCT Filed: Oct. 5, 2022
(86) PCT No.: PCT/JP2022/037256

§ 371 Date: Apr. 2, 2024

(30) Foreign Application Priority Data
Oct. 5, 2021 (JP) 2021-164247

(51) Int. Cl. G06F 3/14; G06T 11/00

(52) U.S. Cl. CPC G06F 3/1454; G06T 11/00

(57) ABSTRACT

A work assistance system includes a first system used by a first user, and a second system used by a second user who gives an instruction about work in a space where the first user is present. The second system includes: a second display unit that displays an image in the space captured by the first system; a data generation unit that generates instruction reference position data indicating an instruction reference position corresponding to image capturing position data and instruction position data indicating an instruction position based on an operation of designating the instruction position on the image; and a second communication unit that outputs the instruction reference position data and the instruction position data. The virtual object generation unit generates a work assistance virtual object based on the instruction reference position data and the instruction position data.

### TECHNICAL FIELD

The present disclosure relates to a work assistance system for assisting work.

### BACKGROUND ART

Conventionally, a work assistance system for assisting work in a space where a first user, who is a worker, is present based on an instruction from a second user, who is an instructor in a remote location, has been known. This type of work assistance system is disclosed, for example, in Patent Literature 1.

In the system disclosed in Patent Literature 1, data communication of a work video of a worker and a work instruction video of an instructor is performed between a worker side computer and an instructor side computer connected via a communication network. In this system, the instructor can give a work instruction to the worker through the work instruction video while watching the work video displayed on an instructor side monitor. Meanwhile, the worker can perform the work while checking the work instruction by using the work instruction video displayed on a worker side monitor.

However, when performing data communication of videos including the work video and the work instruction video via the communication network, since the videos have a relatively large data capacity, depending on the environment of the communication network, there is a possibility that a problem such as the data communication requires a long time may occur. Furthermore, for example, if a worker moves without checking the work instruction video, even if the worker checks the work instruction video at the current location of the movement destination, it is difficult to accurately perceive the position of the work instruction shown in the work instruction video.

### CITATION LIST

### Patent Literature

Patent Literature 1: Japanese Patent No. 6179927

### SUMMARY OF INVENTION

An object of the present disclosure is to provide a work assistance system that can minimize the data capacity when performing data communication between the first user side and the second user side, and that allows the first user to accurately perceive the position of the instruction by the second user.

A work assistance system according to one aspect of the present disclosure includes a first system used by a first user, and a second system used by a second user who gives an instruction about work in a space where the first user is present. The first system includes: an image capturing unit that captures an image in the space; a virtual object generation unit that generates a work assistance virtual object that assists the work in the space; a first display unit that displays the work assistance virtual object superimposed on the space; and a first communication unit that outputs image capturing position data indicating an image capturing position of the image capturing unit in the space and the image. The second system includes: a second display unit that displays the image; a data generation unit that generates instruction reference position data indicating an instruction reference position corresponding to the image capturing position data and instruction position data indicating an instruction position based on an operation of designating the instruction position on the image; and a second communication unit that outputs the instruction reference position data and the instruction position data. The virtual object generation unit generates the work assistance virtual object based on the instruction reference position data and the instruction position data.

The present disclosure can provide a work assistance system that can minimize the data capacity when performing data communication between the first user side and the second user side, and that allows the first user to accurately perceive the position of the instruction by the second user.

### BRIEF DESCRIPTION OF DRAWINGS

FIG. 1 is a block diagram showing a configuration of a work assistance system of the present disclosure.

FIG. 2 is a block diagram showing a configuration of a first system provided in the work assistance system.

FIG. 3 is a diagram showing the state of a real space seen through a first display unit of a first display device provided in the first system.

FIG. 4 is a block diagram showing a configuration of a second system provided in the work assistance system.

FIG. 5 is a diagram showing a display state of a second display unit in a second display device provided in the second system.

FIG. 6 is a diagram showing the display state of the second display unit when an operation of designating an instruction position is performed on an image displayed in the second display unit of the second display device.

FIG. 7 is a diagram showing the state of the real space seen through the first display unit with a work assistance virtual object displayed in the first display unit of the first display device.

FIG. 8 is a diagram showing a first example of the display state of the first display device when an operation of designating the same instruction position is performed on a plurality of images in the second display device.

FIG. 9 is a diagram showing a second example of the display state of the first display device when the operation of designating the same instruction position is performed on the plurality of images in the second display device.

FIG. 10 is a diagram showing a first example of the display state of the first display device when the work assistance virtual object is generated based on three-dimensional scan data by a scan unit in the first display device.

FIG. 11 is a diagram showing a second example of the display state of the first display device when the work assistance virtual object is generated based on three-dimensional scan data by the scan unit in the first display device.

FIG. 12 is a diagram showing the display state of the first display device when an operation of designating the instruction position is performed continuously on images in the second display device.

FIG. 13 is a flowchart showing a work assistance method using the work assistance system.

### DESCRIPTION OF EMBODIMENTS

Embodiments of a work assistance system according to the present disclosure will be described below with reference to the drawings.

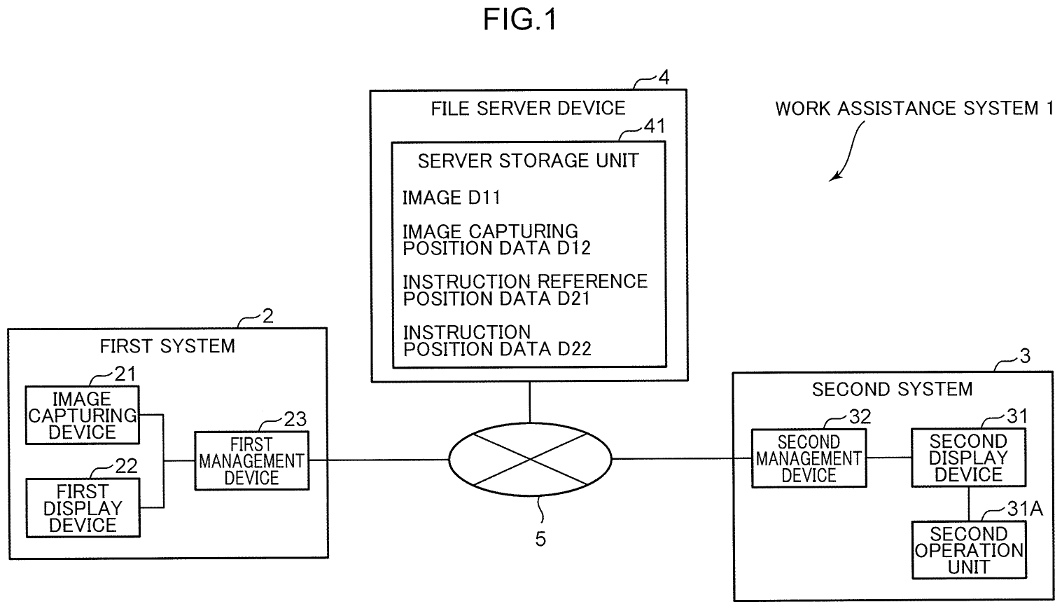

The work assistance system 1 shown in FIG. 1 is a system for assisting work in a space where a first user is present based on an instruction by a second user who is in a remote location. Examples of the first user include a worker who actually performs work, a supervisor who supervises the workers' work, and an assistant who assists the workers' work. Examples of the second user include an instructor who gives a work instruction. The work assistance system 1 includes a first system 2 used by the first user and a second system 3 used by the second user.

The first system 2 includes an image capturing device 21, a first display device 22, and a first management device 23. In the first system 2, the image capturing device 21 and the first display device 22 are connected to the first management device 23, and the first management device 23 is connected to a communication network 5. Meanwhile, the second system 3 includes a second display device 31 and a second management device 32. In the second system 3, the second display device 31 is connected to the second management device 32, and the second management device 32 is connected to the communication network 5.

In addition, a file server device 4 is connected to the communication network 5. The file server device 4 is connected to the first management device 23 and the second management device 32 via the communication network 9 to allow data communication. The file server device 4 includes a server storage unit 41 that stores various data used in the first system 2 and the second system 3. Details of the file server device 4 will be described later.

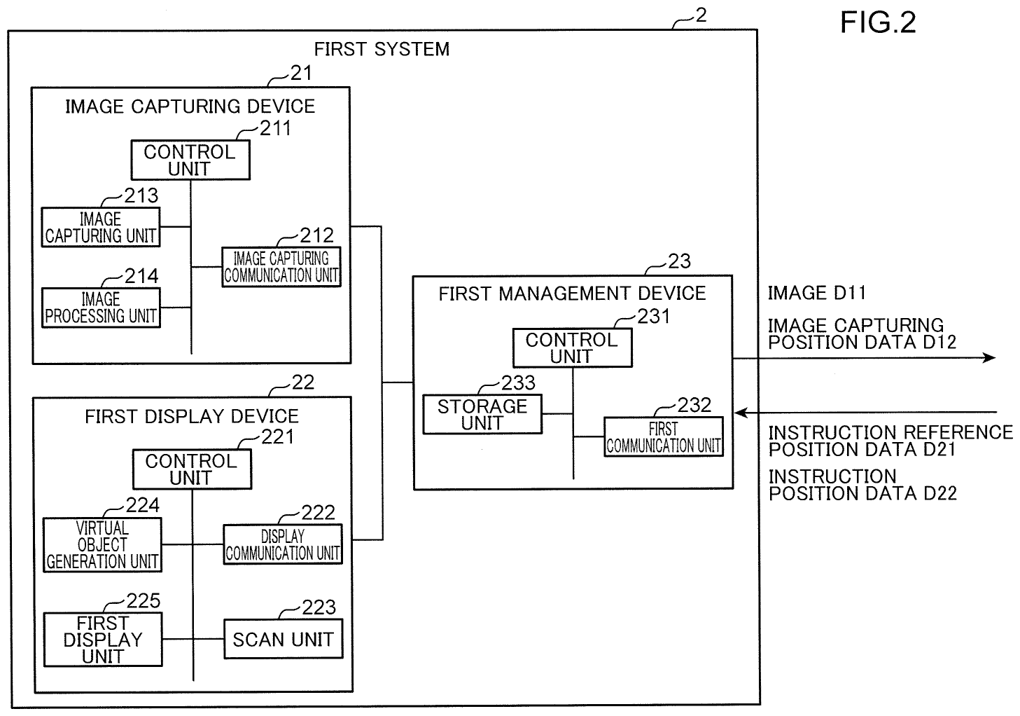

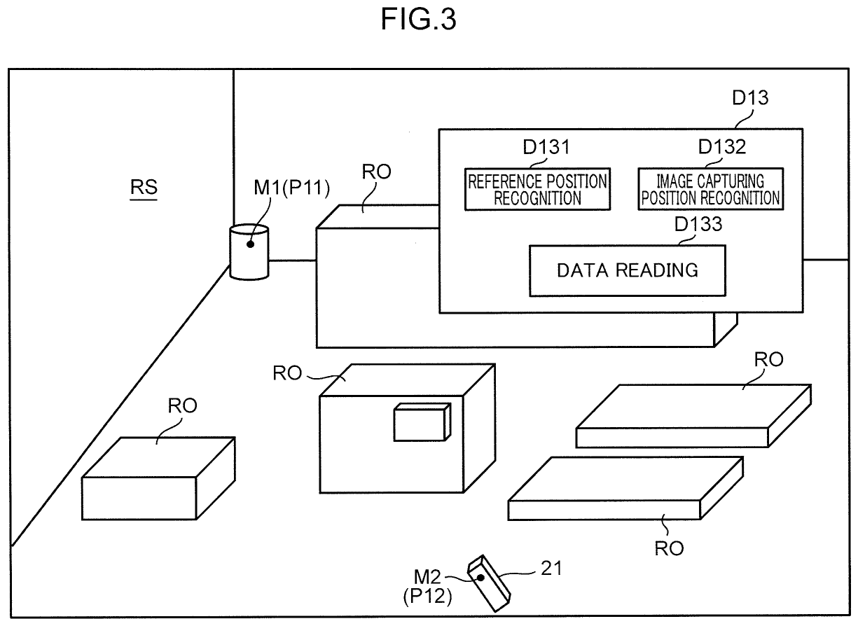

The image capturing device 21, the first display device 22, and the first management device 23, which constitute the first system 2, will be described with reference to FIGS. 2 and 3.

The image capturing device 21 is a device that captures an image D11 in a real space RS where the first user is present. The image D11 captured by the image capturing device 21 is a two-dimensional image. The image capturing device 21 includes a control unit 211, an image capturing communication unit 212, an image capturing unit 213, and an image processing unit 214. In the image capturing device 21, the image capturing communication unit 212, the image capturing unit 213, and the image processing unit 214 are controlled by the control unit 211. Under the control of the control unit 211, the image capturing unit 213 and the image processing unit 214 acquire the image D11, and the image capturing communication unit 212 transmits the image D11 to the first management device 23.

The image capturing unit 213 includes a plurality of image capturing bodies each equipped with an image-forming optical system and an image capturing element. The image-forming optical system includes optical elements such as lenses, prisms, filters, and aperture diaphragms. The image capturing element is an element such as a charge coupled device (CCD) or a complementary metal oxide semiconductor (CMOS). The image captured by the image capturing element of each of the plurality of image capturing bodies is transferred to the image processing unit 214.

The image processing unit 214 performs image processing to combine images from the image capturing element of each of the plurality of image capturing bodies. The image processing unit 214 performs image processing to combine each image, thereby generating an omnidirectional image of solid angle 4π steradians as an image G11.

That is, the image capturing device 21 acquires an omnidirectional image, which is captured in all directions centered on the image capturing position in the real space RS where the first user is present, as the image G11. The image G11 is transmitted to the first management device 23 via the image capturing communication unit 212.

The first display device 22 is a display device that displays a virtual object represented by computer graphics (CG) and superimposed on the real space RS where the first user is present. The first user who uses the first display device 22 can experience mixed reality (MR), where the virtual object is combined with the real world in the real space RS. Examples of the first display device 22 include a portable terminal such as a tablet terminal that can be carried by the first user, a head mounted display device that is worn on the head of the first user and used, and an eyeglass-type display device that is worn and used with the feel of wearing glasses on the first user. In the present embodiment, the first display device 22 includes an eyeglass-type display device. In such a first display device 22, the virtual object represented by CG is superimposed on the real world seen through the display.

The first display device 22 includes a control unit 221, a display communication unit 222, a scan unit 223, a virtual object generation unit 224, and a first display unit 225. In the first display device 22, the display communication unit 222, the scan unit 223, the virtual object generation unit 224, and the first display unit 225 are controlled by the control unit 221.

The first display unit 225 is a display that can display the virtual object as superimposed on the real space RS. In the first display device 22 including an eyeglass-type display device, the first display unit 225 has light-transmitting properties. With the first display device 22 worn on the first user, the first display unit 225 is disposed to cover both eyes of the first user from outside. In this state, the first user can see the inside of the real space RS through the first display unit 225. The virtual object displayed in the first display unit 225 is generated by the virtual object generation unit 224.

The virtual object generation unit 224 generates a work assistance virtual object as a virtual object to assist the work of the first user in the real space RS. Details of the operation of generating the work assistance virtual object by the virtual object generation unit 224 will be described later. Note that in the first system 2, the virtual object generation unit 224 is not limited to being provided in the first display device 22. The virtual object generation unit 224 may be provided in the first management device 23.

The scan unit 223 includes a plurality of cameras, sensors, and the like that are disposed at positions close to the first display unit 225. The scan unit 223 scans the inside of the three-dimensional real space RS, thereby generating three-dimensional scan data about a real object RO in the real space RS. The first display device 22 has a simultaneous localization and mapping (SLAM) function, which is a self-location estimation function based on the operation of generating the three-dimensional scan data by the scan unit 223.

When the first user uses the first display device 22, as shown in FIG. 3, an operation guide virtual object D13 as the virtual object represented by CG is displayed in the first display unit 225 to be superimposed on the real space RS seen through the first display unit 225. The operation guide virtual object D13 is a virtual object to guide the operation of the first user, in which a reference position recognition area D131, an image capturing position recognition area D132, and a data reading area D133 are disposed.

With a work reference mark M1 placed at a work reference position P11 in the real space RS seen through the first display unit 225, when the operation of selecting the reference position recognition area D131 is performed by the first user, the scan unit 223 generates the three-dimensional scan data about the work reference mark M1. The three-dimensional scan data in this case will be work reference position data indicating the work reference position P11 where the work reference mark M1 is placed in the three-dimensional real space RS.

Based on the three-dimensional scan data by the scan unit 223, the control unit 221 in the first display device 22 recognizes the position of the first user who wears the first display device 22 in the real space RS with respect to the work reference position P11 indicated by the work reference position data, and recognizes the orientation of the first user's point of view.

When using the image capturing device 21 to capture the image D11 in the real space RS, the operation of selecting the image capturing position recognition area D132 is performed by the first user, with the image capturing device 21 seen through the first display unit 225. In this case, the scan unit 223 generates three-dimensional scan data about an image capturing mark M2 attached to the image capturing device 21. The three-dimensional scan data in this case is image capturing position data D12 indicating an image capturing position P12 by the image capturing device 21 with respect to the work reference position P11 indicated by the work reference position data in the real space RS. The image capturing position data D12 is transmitted to the first management device 23 via the display communication unit 222.

Note that when the operation of selecting the data reading area D133 is performed by the first user, the display communication unit 222 receives, via the first management device 23, instruction reference position data D21 and instruction position data D22 described later, which are stored in the server storage unit 41 of the file server device 4. The instruction reference position data D21 and the instruction position data D22 received by the display communication unit 222 are referred to by the virtual object generation unit 224.

The first management device 23 includes, for example, a personal computer. The first management device 23 includes a control unit 231, a first communication unit 232, and a storage unit 233. In the first management device 23, the first communication unit 232 and the storage unit 233 are controlled by the control unit 231.

The first communication unit 232 performs data communication with the image capturing device 21 and the first display device 22, and performs data communication with the file server device 4 via the communication network 5. The first communication unit 232 receives the image D11 from the image capturing device 21 and the image capturing position data D12 from the first display device 22, and transmits the received image D11 and the image capturing position data D12 to the file server device 4 via the communication network 5. In addition, the first communication unit 232 receives the instruction reference position data D21 and the instruction position data D22 from the file server device 4 via the communication network 5, and transmits each of the received position data D21 and D22 to the first display device 22.

The storage unit 233 stores the image D11 and the image capturing position data D12 received by the first communication unit 232 in association with each other. The image D11 and the image capturing position data D12 are transmitted to the file server device 4 via the first communication unit 232 in association with each other. The file server device 4 stores the received image D11 and the image capturing position data D12 in the server storage unit 41.

Note that in the first system 2, the first management device 23 may be incorporated into the first display device 22. That is, the first display device 22 may have functions of the first communication unit 232 and the storage unit 233 described above.

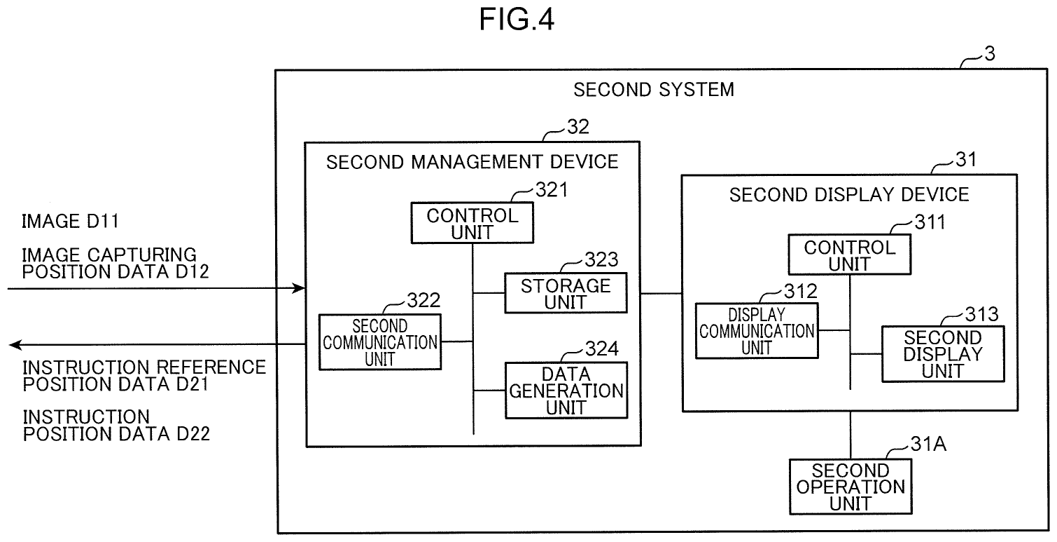

Next, with reference to FIGS. 4 to 6 in addition to FIG. 1, the second display device 31 and the second management device 32, which constitute the second system 3, will be described.

The second management device 32 includes, for example, a personal computer. The second management device 32 has a function of performing data communication with the file server device 4 via the communication network 5, and a function of controlling the second display device 31. The second management device 32 includes a control unit 321, a second communication unit 322, a storage unit 323, and a data generation unit 324. In the second management device 32, the second communication unit 322, the storage unit 323, and the data generation unit 324 are controlled by the control unit 321.

The second communication unit 322 performs data communication with the second display device 31, and performs data communication with the file server device 4 via the communication network 5. The second communication unit 322 receives the image D11 and the image capturing position data D12 from the file server device 4 via the communication network 5, and transmits the received image D11 to the second display device 31. In addition, the second communication unit 322 transmits the instruction reference position data D21 and the instruction position data D22 generated by the data generation unit 324 described later to the file server device 4 via the communication network 5.

The storage unit 323 stores the instruction reference position data D21 and the instruction position data D22 generated by the data generation unit 324 in association with each other. The instruction reference position data D21 and the instruction position data D22 are transmitted to the file server device 4 via the second communication unit 322 in association with each other.

The data generation unit 324 performs the data generation process to generate the instruction reference position data D21 and the instruction position data D22. The data generation process by the data generation unit 324 is performed in conjunction with image display by the second display device 31. Therefore, the data generation process by the data generation unit 324 will be described in association with the second display device 31.

The second display device 31 is a display device that displays virtual reality (VR) images. Examples of the second display device 31 include a portable terminal such as a tablet terminal that can be carried by the second user, a head mounted display device that is worn on the head of the second user and used, and a personal computer. In the present embodiment, the second display device 31 includes a head mounted display device.

The second display device 31 includes a control unit 311, a display communication unit 312, and a second display unit 313. In the second display device 31, the display communication unit 312 and the second display unit 313 are controlled by the control unit 311. In addition, the second display device 31 is configured to accept a command signal from a second operation unit 31A. The second operation unit 31A includes, for example, a controller operated by the second user. In addition, the second operation unit 31A may include a sensor mounted on the second display device 31 and tracking movements of the hand or finger of the second user, or the like.

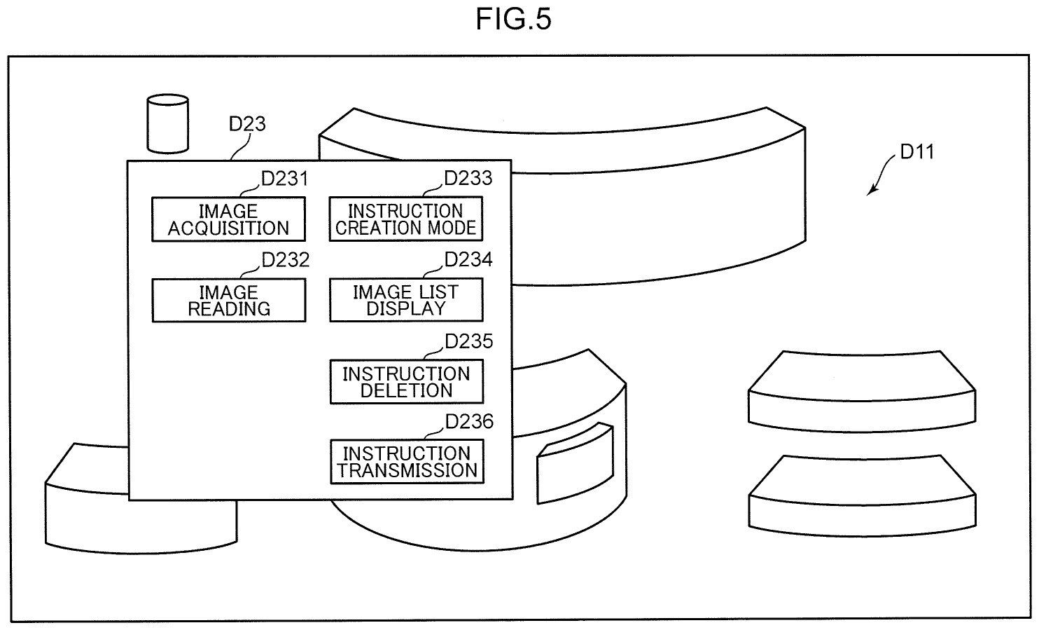

The second display unit 313 is a display that can display images. When the second user uses the second display device 31, as shown in FIG. 5, an operation guide virtual object D23 as a virtual object represented by CG is displayed in the second display unit 313. The operation guide virtual object D23 is a virtual object to guide the operation by the second user via the second operation unit 31A, in which an image acquisition area D231, an image reading area D232, an instruction creation mode area D233, an image list display area D234, an instruction deletion area D235, and an instruction transmission area D236 are disposed.

When a command signal to select the image acquisition area D231 is output from the second operation unit 31A, the display communication unit 312 receives and acquires, via the second management device 32, the image D11 and the image capturing position data D12 stored in the server storage unit 41 of the file server device 4. In this way, the display communication unit 312 has a function as an acquisition unit that acquires the image D11 and the image capturing position data D12.

When a command signal to select the image reading area D232 is output from the second operation unit 31A, the second display unit 313 reads the image D11 and the image capturing position data D12 acquired by the display communication unit 312.

When a command signal to select the instruction creation mode area D233 is output from the second operation unit 31A, the second display device 31 is set to a mode to create data about the instruction position for instructing the work position by the first user.

When a command signal to select the image list display area D234 is output from the second operation unit 31A, the second display unit 313 lists the images D11 in a state divided for each image capturing position data D12. When a command signal to select one image D11 from among the listed images D11 is output from the second operation unit 31A, the second display unit 313 displays the selected image D11.

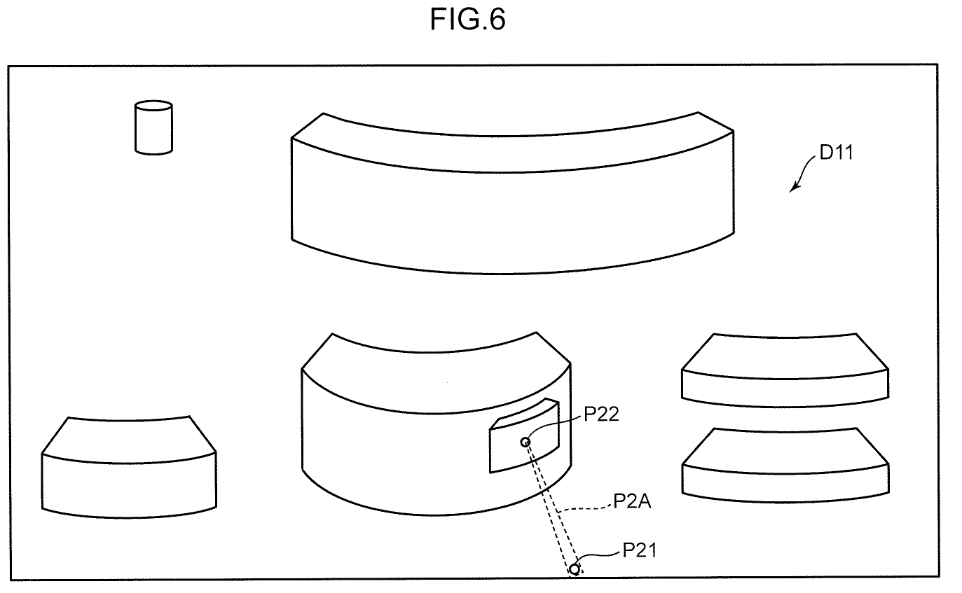

As shown in FIG. 6, with the image D11 displayed in the second display unit 313, based on the operation by the second operation unit 31A that designates an instruction position P22 on the image D11, the data generation unit 324 of the second management device 32 generates the instruction reference position data D21 and the instruction position data D22. The instruction reference position data D21 is data indicating an instruction reference position P21 corresponding to the image capturing position data D12 associated with the image D11. The instruction position data D22 is data indicating the instruction position P22 for instructing the work position of the first user. When the instruction reference position data D21 and the instruction position data D22 are generated by the data generation unit 324, a work instruction virtual object P2A indicating a virtual object extending from the instruction reference position P21 to the instruction position P22 is displayed in the second display unit 313 to overlap the image D11. By checking the work instruction virtual object P2A displayed in the second display unit 313, the second user can perceive the instruction position P22.

In the second management device 32, the instruction reference position data D21 and the instruction position data D22 generated by the data generation unit 324 are stored in the storage unit 323 in association with each other.

Returning to FIG. 5, when a command signal to select the instruction deletion area D235 on the operation guide virtual object D23 displayed in the second display unit 313 is output from the second operation unit 31A, in the second management device 32, the data generation unit 324 deletes the created instruction reference position data D21 and the instruction position data D22.

When a command signal to select the instruction transmission area D236 on the operation guide virtual object D23 displayed in the second display unit 313 is output from the second operation unit 31A, in the second management device 32, the second communication unit 322 transmits the instruction reference position data D21 and the instruction position data D22 stored in the storage unit 323 to the file server device 4 via the communication network 5.

The file server device 4 stores the received instruction reference position data D21 and the instruction position data D22 in the server storage unit 41.

As described above, in the first display device 22, when the operation of selecting the data reading area D133 on the operation guide virtual object D13 displayed in the first display unit 225 is performed by the first user, the display communication unit 222 receives, via the first management device 23, the instruction reference position data D21 and the instruction position data D22 stored in the server storage unit 41 of the file server device 4.

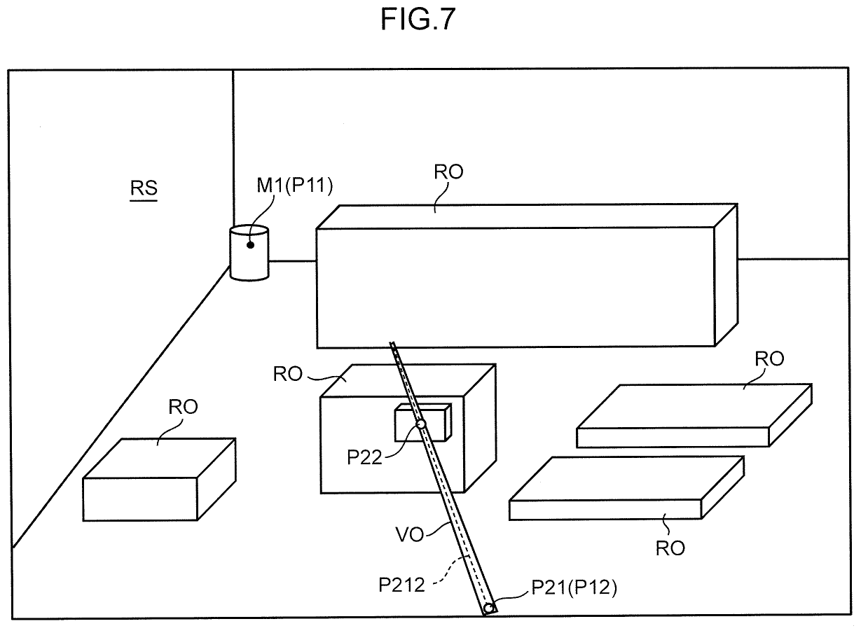

As shown in FIG. 7, in the first display device 22, the virtual object generation unit 224 generates a work assistance virtual object VO that is displayed in the first display unit 225 based on the instruction reference position data D21 and the instruction position data D22. The work assistance virtual object VO is a virtual object to assist the work by the first user. The virtual object generation unit 224 generates, as the work assistance virtual object VO, a virtual object along a straight line P212 passing through the instruction reference position P21 indicated by the instruction reference position data D21 and the instruction position P22 indicated by the instruction position data D22. At this time, the instruction reference position P21 indicated by the instruction reference position data D21 may agree with the image capturing position P12 indicated by the image capturing position data D12, or may be position shifted from the image capturing position P12.

As described above, in the first system 2, the image capturing position data D12 of the image capturing device 21 and the image D11 captured by the image capturing device 21 are output via the first communication unit 232 of the first management device 23. Meanwhile, in the second system 3, with the image D11 displayed in the second display device 31, the instruction reference position data D21 and the instruction position data D22 are generated by the data generation unit 324 of the second management device 32. Each of the generated position data D21 and D22 is output via the second communication unit 322 of the second management device 32. In the first display device 22 of the first system 2, the virtual object generation unit 224 generates the work assistance virtual object VO based on the instruction reference position data D21 and the instruction position data D22, and the first display unit 225 displays the work assistance virtual object VO.

In such a work assistance system 1 including the first system 2 and the second system 3, the image capturing position data D12 and the image D11 are transmitted from the first system 2 side to the second system 3 side, and the instruction reference position data D21 and the instruction position data D22 are transmitted from the second system 3 side to the first system 2 side. By performing data communication of each position data of the image capturing position data D12, the instruction reference position data D21, and the instruction position data D22, and the image D11 between the first system 2 and the second system 3, the data capacity when performing data communication can be minimized, compared to the case where data communication of a video is performed as in the conventional technology.

In the first display device 22 of the first system 2, the first display unit 225 displays the work assistance virtual object VO generated by the virtual object generation unit 224 to be superimposed on the real space RS where the first user is present. As described above, the work assistance virtual object VO is a virtual object generated based on each position data of the instruction reference position data D21 and the instruction position data D22. Therefore, the first display unit 225 displays the work assistance virtual object VO to remain fixed at a certain position based on the instruction reference position P21 indicated by the instruction reference position data D21 and the instruction position P22 indicated by the instruction position data D22 in the real space RS where the first user is present. That is, even if the first user who uses the first display device 22 moves in the real space RS or changes the orientation of the viewpoint, the work assistance virtual object VO remains fixed at a certain position in the real space RS. This allows the worker who uses the first display device 22 to accurately perceive the position of the work instruction by the second user by checking the work assistance virtual object VO displayed in the first display unit 225 to remain fixed at a certain position in the real space RS.

Next, assume a case where operations of designating the same instruction position P22 are each performed on each of a plurality of the images D11 with different image capturing position data D12, as displayed in the second display device 31. In this case, the data generation unit 324 of the second management device 32 generates a plurality of combined data of the instruction reference position data D21 and the instruction position data D22 in response to each operation on each of the plurality of images D11.

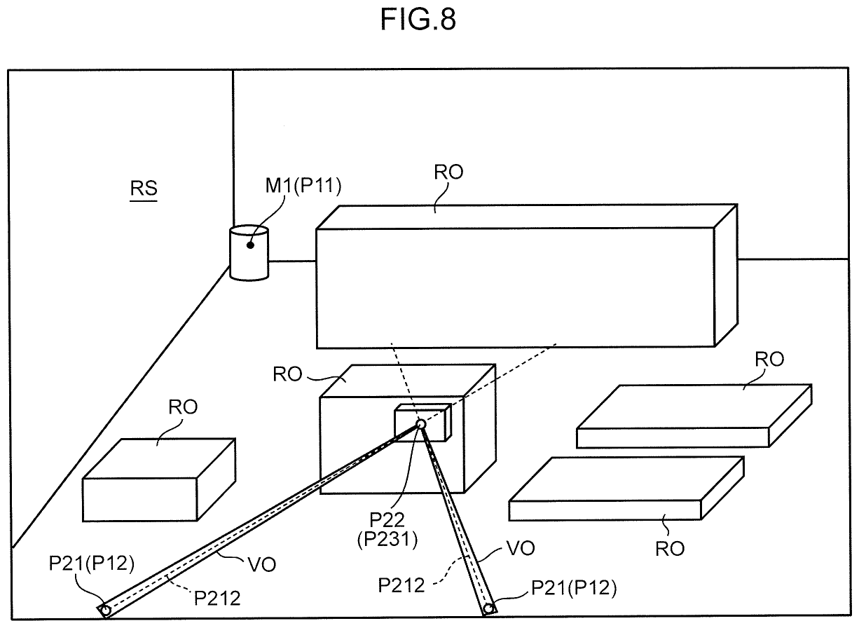

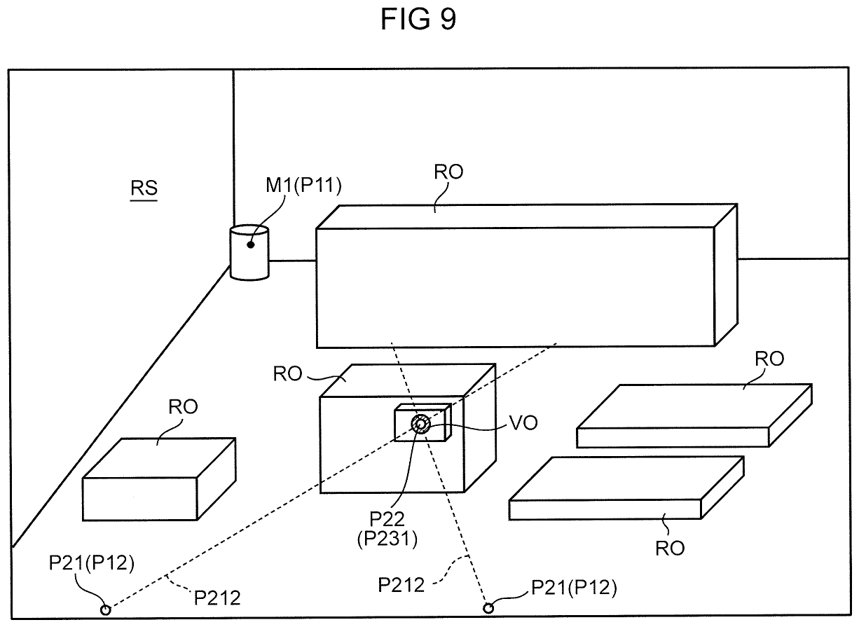

In this case, as shown in FIGS. 8 and 9, the virtual object generation unit 224 of the first display device 22 calculates a first intersection point P231 between the straight lines P212 passing through each position P21 and P22 indicated by the instruction reference position data D21 and the instruction position data D22 of each of the plurality of combined data. Then, the virtual object generation unit 224 generates the work assistance virtual object VO based on the calculated first intersection point P231. In the first display device 22, such a work assistance virtual object VO is displayed in the first display unit 225 to remain fixed at a certain position based on the first intersection point P231 in the real space RS where the first user is present. In this case, the instruction position P22 in the three-dimensional real space RS can be represented by the position of the work assistance virtual object VO based on the first intersection point P231. This allows the first user who uses the first display device 22 to perceive the position of the work instruction more accurately by the second user by checking the work assistance virtual object VO displayed in the first display unit 225 to remain fixed at a certain position based on the first intersection point P231 in the real space RS.

In the example shown in FIG. 8, the virtual object generation unit 224 generates, as the work assistance virtual object VO, each virtual object along each of the plurality of line segments P212 extending from each of the plurality of instruction reference positions P21 indicated by the instruction reference position data D21 in each of the plurality of combined data to the first intersection point P231. In this case, the instruction position P22 in the three-dimensional real space RS can be represented by the position of an end corresponding to the first intersection point P231 in the work assistance virtual object VO. This allows the first user who uses the first display device 22 to perceive the position of the work instruction more accurately by the second user by checking the position of the end corresponding to the first intersection point P231 in the work assistance virtual object VO displayed in the first display unit 225 to remain fixed at a certain position in the real space RS.

In the example shown in FIG. 9, the virtual object generation unit 224 generates a virtual mark placed at the first intersection point P231 as the work assistance virtual object VO. In this case, the instruction position P22 in the three-dimensional real space RS can be represented by the position of the virtual mark placed at the first intersection point P231. This allows the first user who uses the first display device 22 to perceive the position of the work instruction more accurately by the second user by checking the work assistance virtual object VO including the virtual mark displayed in the first display unit 225 to remain fixed at a certain position in the real space RS corresponding to the first intersection point P231.

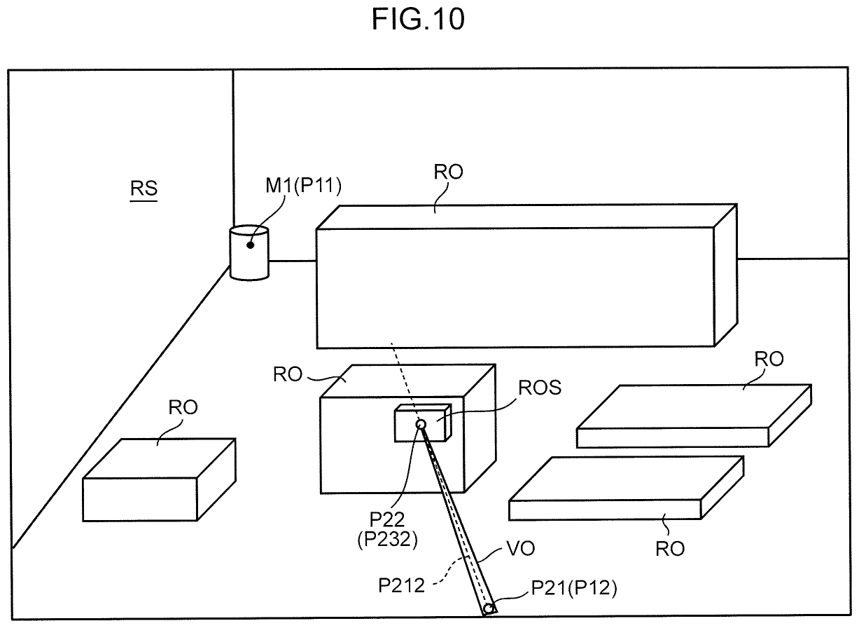

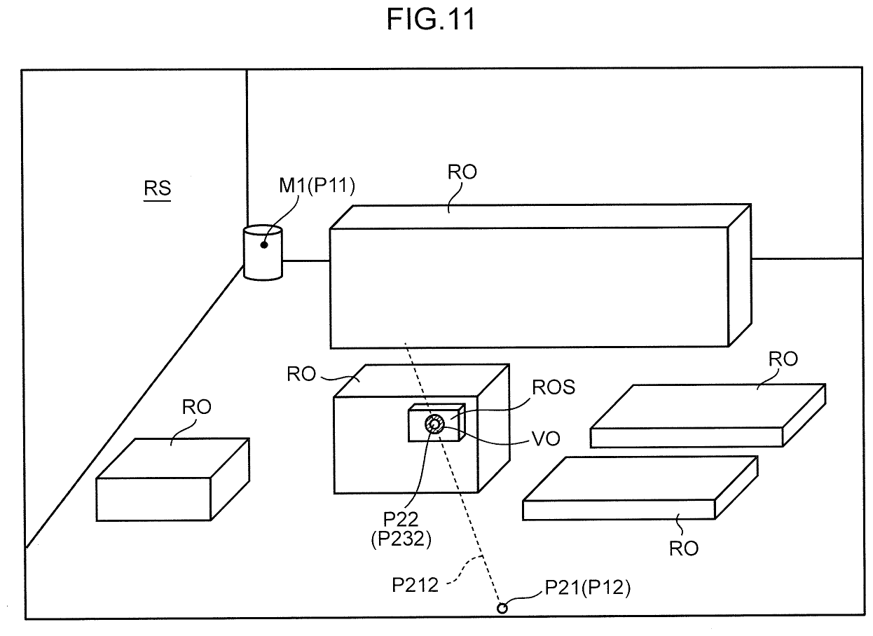

As shown in FIGS. 10 and 11, the virtual object generation unit 224 in the first display device 22 may be configured to generate the work assistance virtual object VO based on the three-dimensional scan data generated by the scan unit 223. Specifically, the virtual object generation unit 224 calculates a second intersection point P232 of the straight line P212 passing through the instruction reference position P21 indicated by the instruction reference position data D21 and the instruction position P22 indicated by the instruction position data D22, and an outer surface of a specific real object ROS in the real space RS based on the three-dimensional scan data generated by the scan unit 223. Then, the virtual object generation unit 224 generates the work assistance virtual object VO based on the calculated second intersection point P232.

In the first display device 22, such a work assistance virtual object VO is displayed in the first display unit 225 to remain fixed at a certain position based on the second intersection point P232 in the real space RS where the first user is present. In this case, the instruction position P22 in the three-dimensional real space RS can be represented by the position of the work assistance virtual object VO based on the second intersection point P232. This allows the first user who uses the first display device 22 to perceive the position of the work instruction more accurately by the second user by checking the work assistance virtual object VO displayed in the first display unit 225 to remain fixed at a certain position based on the second intersection point P232 in the real space RS.

In the example shown in FIG. 10, the virtual object generation unit 224 generates the virtual object along the line segment P212 extending from the instruction reference position P21 indicated by the instruction reference position data D21 to the second intersection point P232 as the work assistance virtual object VO. In this case, the instruction position P22 in the three-dimensional real space RS can be represented by the position of an end corresponding to the second intersection point P232 in the work assistance virtual object VO. This allows the first user who uses the first display device 22 to perceive the position of the work instruction more accurately by the second user by checking the position of the end corresponding to the second intersection point P232 in the work assistance virtual object VO displayed in the first display unit 225 to remain fixed at a certain position in the real space RS.

In the example shown in FIG. 11, the virtual object generation unit 224 generates a virtual mark placed at the second intersection point P232 as the work assistance virtual object VO. In this case, the instruction position P22 in the three-dimensional real space RS can be represented by the position of the virtual mark placed at the second intersection point P232. This allows the first user who uses the first display device 22 to perceive the position of the work instruction more accurately by the second user by checking the work assistance virtual object VO including the virtual mark displayed in the first display unit 225 to remain fixed at a certain position in the real space RS corresponding to the second intersection point P232.

Next, assume a case where the operation of designating the instruction position P22 on the image D11 displayed in the second display device 31 is performed continuously, such as drawing a circular arc, for example. In this case, the data generation unit 324 of the second management device 32 generates the instruction reference position data D21 corresponding to the image capturing position data D12 associated with the image D11 and the plurality of continuous instruction position data D22 corresponding to the operation performed continuously.

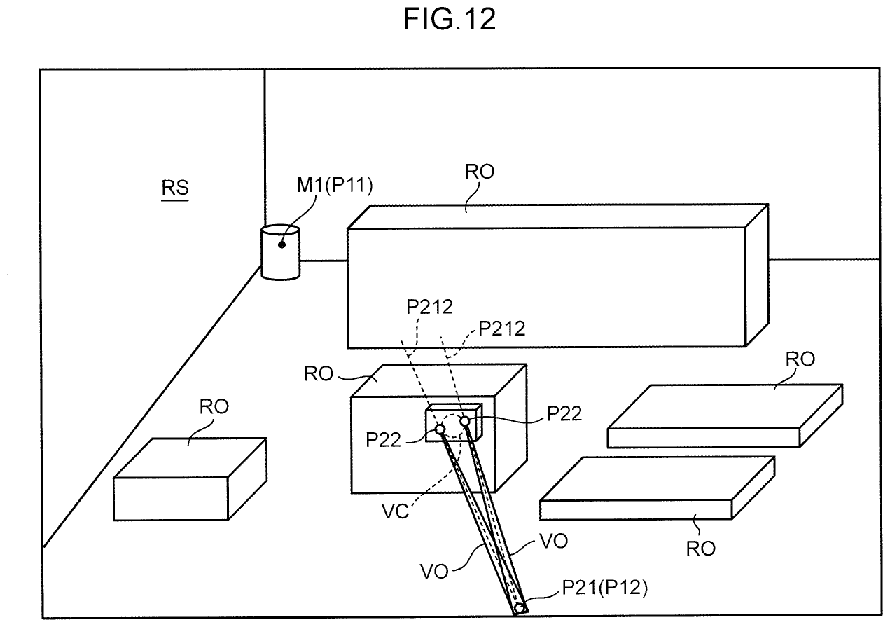

In this case, as shown in FIG. 12, the virtual object generation unit 224 of the first display device 22 generates, as the work assistance virtual objects VO, a plurality of virtual objects along a plurality of straight lines P212 extending from the instruction reference position P21 indicated by the instruction reference position data D21 toward the instruction position P22 indicated by each of the plurality of instruction position data D22. In the first display device 22, such a plurality of work assistance virtual objects VO is displayed in the first display unit 225 to remain fixed at a certain position in the real space RS where the first user is present. In this case, the ends on the opposite side of the instruction reference position P21 side in the plurality of work assistance virtual objects VO are placed along a trajectory VC of the continuous operation when designating the instruction position P22 on the image D11 displayed in the second display device 31. This allows the first user who uses the first display device 22 to perceive the position of the work instruction more accurately by the second user by checking the placement mode of the ends in the plurality of work assistance virtual objects VO that remain fixed at a certain position in the real space RS.

As described above, the image D11, the image capturing position data D12, the instruction reference position data D21, and the instruction position data D22 are stored in the server storage unit 41 of the file server device 4. The file server device 4 is connected to the first communication unit 232 of the first management device 23 and the second communication unit 322 of the second management device 32 via the communication network 5 to allow data communication. This allows the second user to use the second management device 32 at desired timing that suits the user's convenience to read the image D11 and the image capturing position data D12 from the file server device 4, and to create the work instruction while checking the situation in the real space RS where the first user is present based on the image D11 by using the second display device 31. Meanwhile, the first user can use the first management device 23 at desired timing that suits the user's convenience to read the instruction reference position data D21 and the instruction position data D22 from the file server device 4, and can perform the work while checking the work assistance virtual object VO by using the first display device 22.

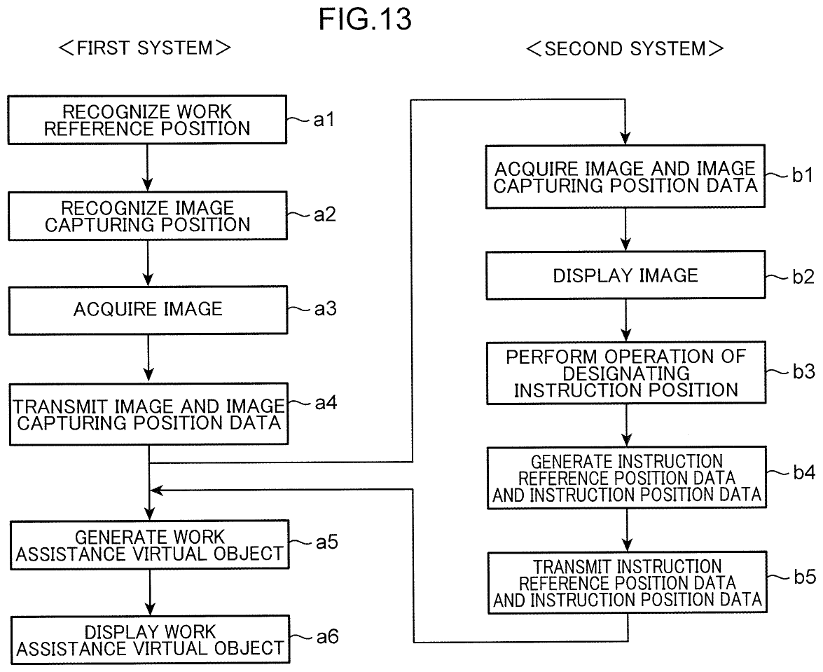

Next, a work assistance method using the work assistance system 1 will be described with reference to the flowchart in FIG. 13.

When the first user uses the first display device 22, the operation guide virtual object D13 is displayed in the first display unit 225 to be superimposed on the real space RS seen through the first display unit 225 (FIG. 3). With the work reference mark M1 placed at the work reference position P11 in the real space RS seen through the first display unit 225, when the operation of selecting the reference position recognition area D131 is performed by the first user, the scan unit 223 generates the three-dimensional scan data about the work reference mark M1. As a result, the control unit 221 in the first display device 22 recognizes the work reference position P11 where the work reference mark M1 is placed in the three-dimensional real space RS (step a1).

When using the image capturing device 21 to capture the image D11 in the real space RS, the operation of selecting the image capturing position recognition area D132 is performed by the first user, with the image capturing device 21 seen through the first display unit 225. In this case, the scan unit 223 generates three-dimensional scan data about the image capturing mark M2 attached to the image capturing device 21. As a result, the control unit 221 in the first display device 22 recognizes the image capturing position P12 by the image capturing device 21 with respect to the work reference position P11 in the real space RS (step a2). The image capturing position data D12 indicating the image capturing position P12 is transmitted to the first management device 23 via the display communication unit 222.

The image capturing device 21 acquires the image D11 by capturing an image in the real space RS at the image capturing position P12 indicated by the image capturing position data D12 (step a3). In the image capturing device 21, the image capturing communication unit 212 transmits the image D11 to the first management device 23.

In the first management device 23 that receives the image D11 from the image capturing device 21 and the image capturing position data D12 from the first display device 22, the storage unit 233 stores the image D11 and the image capturing position data D12 in association with each other. Then, the first communication unit 232 transmits the image D11 and the image capturing position data D12 to the file server device 4 via the communication network 5 (step a4). The file server device 4 stores the received image D11 and the image capturing position data D12 in the server storage unit 41.

When the second user uses the second display device 31, the operation guide virtual object D23 is displayed in the second display unit 313 (FIG. 5). In the second display device 31, when a command signal to select the image acquisition area D231 is output from the second operation unit 31A, the display communication unit 312 receives and acquires, via the second management device 32, the image D11 and the image capturing position data D12 stored in the server storage unit 41 of the file server device 4 (step b1).

In the second display device 31, after a command signal to select the image reading area D232 and the instruction creation mode area D233, when a command signal to select the image list display area D234 is output from the second operation unit 31A, the second display unit 313 lists the images D11 in a state divided for each image capturing position data D12. When a command signal to select one image D11 from among the listed images D11 is output from the second operation unit 31A, the second display unit 313 displays the selected image D11 (step b2).

With the image D11 displayed in the second display unit 313, the operation of designating the instruction position P22 on the image D11 is performed by the second operation unit 31A (step b3). In this case, the data generation unit 324 of the second management device 32 generates the instruction reference position data D21 and the instruction position data D22 (FIG. 6, step b4).

When a command signal to select the instruction transmission area D236 on the operation guide virtual object D23 displayed in the second display unit 313 is output from the second operation unit 31A, in the second management device 32, the second communication unit 322 transmits the instruction reference position data D21 and the instruction position data D22 to the file server device 4 via the communication network 5 (step b5). The file server device 4 stores the received instruction reference position data D21 and the instruction position data D22 in the server storage unit 41.

In the first display device 22, when the operation of selecting the data reading area D133 on the operation guide virtual object D13 displayed in the first display unit 225 is performed by the first user, the display communication unit 222 receives, via the first management device 23, the instruction reference position data D21 and the instruction position data D22 stored in the server storage unit 41 of the file server device 4.

The virtual object generation unit 224 in the first display device 22 generates the work assistance virtual object VO that is displayed in the first display unit 225 based on the instruction reference position data D21 and the instruction position data D22 (FIGS. 7 to 12, step a5).

Then, the first display unit 225 in the first display device 22 displays the work assistance virtual object VO superimposed on the real space RS where the first user is present (step a6). In this case, the first display unit 225 displays the work assistance virtual object VO to remain fixed at a certain position based on the instruction reference position P21 indicated by the instruction reference position data D21 and the instruction position P22 indicated by the instruction position data D22 in the real space RS. This allows the first user who uses the first display device 22 to accurately perceive the position of the work instruction by the second user by checking the work assistance virtual object VO displayed in the first display unit 225 to remain fixed at a certain position in the real space RS.

The work assistance system 1 having the configuration in which the file server device 4 is connected to the first communication unit 232 of the first system 2 and the second communication unit 322 of the second system 3 via the communication network 5 to allow data communication has been described, but is not limited to such a configuration. The work assistance system 1 may include another server device such as an email server device instead of the file server device 4. The work assistance system 1 may have a configuration that does not include a server device such as the file server device 4. In this case, the first communication unit 232 of the first system 2 and the second communication unit 322 of the second system 3 are connected via the communication network 5 to allow data communication.

### Conclusion of Present Disclosure

The specific embodiments described above include the disclosure having the following configuration.

A work assistance system according to the present disclosure includes a first system used by a first user, and a second system used by a second user who gives an instruction about work in a space where the first user is present. The first system includes: an image capturing unit that captures an image in the space; a virtual object generation unit that generates a work assistance virtual object that assists the work in the space; a first display unit that displays the work assistance virtual object superimposed on the space; and a first communication unit that outputs image capturing position data indicating an image capturing position of the image capturing unit in the space and the image. The second system includes: a second display unit that displays the image; a data generation unit that generates instruction reference position data indicating an instruction reference position corresponding to the image capturing position data and instruction position data indicating an instruction position based on an operation of designating the instruction position on the image; and a second communication unit that outputs the instruction reference position data and the instruction position data. The virtual object generation unit generates the work assistance virtual object based on the instruction reference position data and the instruction position data.

With this work assistance system, in the first system, the image capturing position data of the image capturing unit and the image captured by the image capturing unit are output via the first communication unit. Meanwhile, in the second system, with the image displayed in the second display unit, the instruction reference position data and the instruction position data are generated by the data generation unit. Each of the generated position data is output via the second communication unit. In the first system, the virtual object generation unit generates the work assistance virtual object based on the instruction reference position data and the instruction position data, and the first display unit displays the work assistance virtual object. In such a work assistance system, the image capturing position data and the image are transmitted from the first system side to the second system side, and the instruction reference position data and the instruction position data are transmitted from the second system side to the first system side. By performing data communication of each position data of the image capturing position data, the instruction reference position data, and the instruction position data, and the image between the first system and the second system, the data capacity when performing data communication can be minimized, compared to the case where data communication of a video is performed as in the conventional technology.

In the first system, the first display unit displays the work assistance virtual object generated by the virtual object generation unit to be superimposed on the space where the first user is present. As described above, the work assistance virtual object is a virtual object generated based on each position data of the instruction reference position data and the instruction position data. Therefore, the first display unit displays the work assistance virtual object to remain fixed at a certain position based on each position indicated by each position data in the space where the first user is present. That is, even if the first user who uses the first display unit moves in the space or changes the orientation of the viewpoint, the work assistance virtual object remains fixed at a certain position in the space. This allows the first user who uses the first display unit to accurately perceive the position of the work instruction by the second user by checking the work assistance virtual object displayed in the first display unit to remain fixed at a certain position in the space.

In the work assistance system, when each of the operations of designating the instruction position on each of a plurality of the images with the image capturing position data different from each other is an operation of designating the same instruction position, the data generation unit generates a plurality of combined data of the instruction reference position data and the instruction position data in response to each of the operations. In this case, the virtual object generation unit calculates a first intersection point of straight lines passing through positions indicated by the instruction reference position data and the instruction position data of each of the plurality of combined data, and generates the work assistance virtual object based on the first intersection point.

In this aspect, when each of the operations of designating the same instruction position on each of the plurality of images with the image capturing position data different from each other is performed, the images being displayed in the second display unit of the second system, the data generation unit generates the plurality of combined data of the instruction reference position data and the instruction position data in response to each of the operations. In this case, the virtual object generation unit of the first system calculates the first intersection point of straight lines passing through positions indicated by the instruction reference position data and the instruction position data of each of the plurality of combined data, and generates the work assistance virtual object based on the first intersection point. In the first system, such a work assistance virtual object is displayed in the first display unit to remain fixed at a certain position based on the first intersection point in the space where the first user is present. In this case, the instruction position in the three-dimensional space can be represented by the position of the work assistance virtual object based on the first intersection point. This allows the first user who uses the first display unit to perceive the position of the work instruction more accurately by the second user by checking the work assistance virtual object displayed in the first display unit to remain fixed at a certain position based on the first intersection point in the space.

In the work assistance system, the virtual object generation unit generates, as the work assistance virtual object, a virtual object along a line segment extending from the instruction reference position indicated by the instruction reference position data of each of the plurality of combined data to the first intersection point.

In this aspect, the virtual object generation unit of the first system generates, as the work assistance virtual object, a virtual object along a line segment extending from the instruction reference position indicated by the instruction reference position data of each of the plurality of combined data to the first intersection point. In this case, the instruction position in the three-dimensional space can be represented by the position of the end corresponding to the first intersection point in the work assistance virtual object. This allows the first user who uses the first display unit to perceive the position of the work instruction more accurately by the second user by checking the position of the end corresponding to the first intersection point in the work assistance virtual object displayed in the first display unit to remain fixed at a certain position in the space.

In the work assistance system, the virtual object generation unit generates a virtual mark placed at the first intersection point as the work assistance virtual object.

In this aspect, the virtual object generation unit of the first system generates the virtual mark placed at the first intersection point as the work assistance virtual object. In this case, the instruction position in the three-dimensional space can be represented by the position of the virtual mark placed at the first intersection point. This allows the first user who uses the first display unit to perceive the position of the work instruction more accurately by the second user by checking the work assistance virtual object including the virtual mark displayed in the first display unit to remain fixed at a certain position corresponding to the first intersection point in the space.

In the work assistance system, the first system further includes a scan unit that generates three-dimensional scan data about a real object in the space by scanning in the space. In this case, the virtual object generation unit calculates a second intersection point of an outer surface of the real object based on the three-dimensional scan data and a straight line passing through positions indicated by the instruction reference position data and the instruction position data, and generates the work assistance virtual object based on the second intersection point.

In this aspect, the virtual object generation unit of the first system calculates the second intersection point of the outer surface of the real object in the space based on the three-dimensional scan data generated by the scan unit and the straight line passing through positions indicated by the instruction reference position data and the instruction position data, and generates the work assistance virtual object based on the second intersection point. In the first system, such a work assistance virtual object is displayed in the first display unit to remain fixed at a certain position based on the second intersection point in the space where the first user is present. In this case, the instruction position in the three-dimensional space can be represented by the position of the work assistance virtual object based on the second intersection point. This allows the first user who uses the first display unit to perceive the position of the work instruction more accurately by the second user by checking the work assistance virtual object displayed in the first display unit to remain fixed at a certain position based on the second intersection point in the space.

In the work assistance system, the virtual object generation unit generates, as the work assistance virtual object, a virtual object along a line segment extending from the instruction reference position indicated by the instruction reference position data to the second intersection point.

In this aspect, the virtual object generation unit of the first system generates, as the work assistance virtual object, the virtual object along the line segment extending from the instruction reference position indicated by the instruction reference position data to the second intersection point. In this case, the instruction position in the three-dimensional space can be represented by the position of the end corresponding to the second intersection point in the work assistance virtual object. This allows the first user who uses the first display unit to perceive the position of the work instruction more accurately by the second user by checking the position of the end corresponding to the second intersection point in the work assistance virtual object displayed in the first display unit to remain fixed at a certain position in the space.

In the work assistance system, the virtual object generation unit generates a virtual mark placed at the second intersection point as the work assistance virtual object.

In this aspect, the virtual object generation unit of the first system generates the virtual mark placed at the second intersection point as the work assistance virtual object. In this case, the instruction position in the three-dimensional space can be represented by the position of the virtual mark placed at the second intersection point. This allows the first user who uses the first display unit to perceive the position of the work instruction more accurately by the second user by checking the work assistance virtual object including the virtual mark displayed in the first display unit to remain fixed at a certain position corresponding to the second intersection point in the space.

In the work assistance system, when the operation of designating the instruction position is continuously performed on the image, the data generation unit generates a plurality of the continuous instruction position data in response to the operation. In this case, the virtual object generation unit generates, as the work assistance virtual object, a plurality of virtual objects along a plurality of straight lines extending from the instruction reference position indicated by the instruction reference position data toward the instruction position indicated by each of the plurality of instruction position data.

In this aspect, when the operation of designating the instruction position on the image displayed in the second display unit is performed continuously, for example, such as drawing a circular arc, the data generation unit generates the plurality of instruction position data corresponding to the operation performed continuously. In this case, the virtual object generation unit of the first system generates, as the work assistance virtual object, the plurality of virtual objects along the plurality of straight lines extending from the instruction reference position indicated by the instruction reference position data toward the instruction position indicated by each of the plurality of instruction position data. In the first system, such a plurality of work assistance virtual objects is displayed in the first display unit to remain fixed at a certain position in the space where the first user is present. In this case, the ends on the opposite side of the instruction reference position side in the plurality of work assistance virtual objects are placed along a trajectory of the continuous operation when designating the instruction position on the image displayed in the second display unit. This allows the first user who uses the first display unit to perceive the position of the work instruction more accurately by the second user by checking the placement mode of the ends in the plurality of work assistance virtual objects that remains fixed at a certain position in the space.

The work assistance system further includes a server device connected to the first communication unit and the second communication unit via a communication network to allow data communication. The server device includes a server storage unit that stores the image capturing position data, the image, the instruction reference position data, and the instruction position data.

In this aspect, the image capturing position data, the image, the instruction reference position data, and the instruction position data are stored in the server storage unit of the server device. The server device is connected to the first communication unit and the second communication unit via the communication network to allow data communication. This allows the second user to use the second system at desired timing that suits the user's convenience to read the image capturing position data and the image from the server device, and to create the work instruction while checking the situation in the space where the first user is present based on the image by using the second display unit. Meanwhile, the first user can use the first system at desired timing that suits the user's convenience to read the instruction reference position data and the instruction position data from the server device, and can perform the work while checking the work assistance virtual object by using the first display unit.

1. A work assistance system comprising:
a first system used by a first user; and
a second system used by a second user who gives an instruction about work in a space where the first user is present,
wherein the first system includes:
an image capturing unit that captures an image in the space;
a virtual object generation unit that generates a work assistance virtual object that assists the work in the space;
a first display unit that displays the work assistance virtual object superimposed on the space; and
a first communication unit that outputs image capturing position data indicating an image capturing position of the image capturing unit in the space and the image,
the second system includes:
a second display unit that displays the image;
a data generation unit that generates instruction reference position data indicating an instruction reference position corresponding to the image capturing position data and instruction position data indicating an instruction position based on an operation of designating the instruction position on the image; and
a second communication unit that outputs the instruction reference position data and the instruction position data, and
the virtual object generation unit generates the work assistance virtual object based on the instruction reference position data and the instruction position data.

2. The work assistance system according to claim 1, wherein
when each of the operations of designating the instruction position on each of a plurality of the images with the image capturing position data different from each other is an operation of designating the same instruction position, the data generation unit generates a plurality of combined data of the instruction reference position data and the instruction position data in response to each of the operations, and
the virtual object generation unit calculates a first intersection point of straight lines passing through positions indicated by the instruction reference position data and the instruction position data of each of the plurality of combined data, and generates the work assistance virtual object based on the first intersection point.

3. The work assistance system according to claim 2, wherein the virtual object generation unit generates, as the work assistance virtual object, a virtual object along a line segment extending from the instruction reference position indicated by the instruction reference position data of each of the plurality of combined data to the first intersection point.

4. The work assistance system according to claim 2, wherein the virtual object generation unit generates a virtual mark placed at the first intersection point as the work assistance virtual object.

5. The work assistance system according to claim 1, wherein
the first system further includes a scan unit that generates three-dimensional scan data about a real object in the space by scanning in the space, and
the virtual object generation unit calculates a second intersection point of an outer surface of the real object based on the three-dimensional scan data and a straight line passing through positions indicated by the instruction reference position data and the instruction position data, and generates the work assistance virtual object based on the second intersection point.

6. The work assistance system according to claim 5, wherein the virtual object generation unit generates, as the work assistance virtual object, a virtual object along a line segment extending from the instruction reference position indicated by the instruction reference position data to the second intersection point.

7. The work assistance system according to claim 5, wherein the virtual object generation unit generates a virtual mark placed at the second intersection point as the work assistance virtual object.

8. The work assistance system according to claim 1, wherein
when the operation of designating the instruction position is continuously performed on the image, the data generation unit generates a plurality of the continuous instruction position data in response to the operation, and
the virtual object generation unit generates, as the work assistance virtual object, a plurality of virtual objects along a plurality of straight lines extending from the instruction reference position indicated by the instruction reference position data toward the instruction position indicated by each of the plurality of instruction position data.

9. The work assistance system according to claim 1, further comprising a server device connected to the first communication unit and the second communication unit via a communication network to allow data communication,
wherein the server device includes a server storage unit that stores the image capturing position data, the image, the instruction reference position data, and the instruction position data.
